(19) United States
(12) Patent Application Publication
(10) Pub. No.: US 2011/0203175 A1
(43) Pub. Date: Aug. 25, 2011

(54) MODULAR GARDENING SYSTEM AND METHOD

(76) Inventors: Michael Horito, Provo, UT (US); Lee Croy, Salt Lake City, UT (US); John Omdahl, Lindon, UT (US); Tassanai Poochaneeyangkoon Bates, Provo, UT (US); John Wadley, Logan, UT (US); Marvin Page, Mapleton, UT (US)

(21) Appl. No.: 12/969,458

(22) Filed: Dec. 15, 2010

Related U.S. Application Data
(60) Provisional application No. 61/287,152, filed on Dec. 16, 2009.

(51) Int. Cl. A01G 9/02

(52) U.S. Cl. 47/65.6; 47/66.6; 47/66.7

(57) ABSTRACT

A system and method of modular gardening is disclosed which may include a planter, a planting medium such as peat, coconut husk (coir), etc., a planting template for determining the proper locations for planting seeds, and a planting guide which indicates locations on the planting template that should be used to maximize the amount of vegetables or other plants that can be grown in the planter. The planter may have a raised base with openings for water drainage. The modular planter may also include a channel to retain water which allows for proper hydration of the soil and decreases the frequency needed to water the plants. The modular gardening system may also include a drain pan for receiving the planter and a lid to protect plants grown in the planter from adverse environmental conditions. Additionally, a planting stick may be provided to ensure proper planting depth of seeds for germination.

### PRIORITY

The present application claims the benefit of U.S. Provisional Application Ser. No. 61/287,152, filed Dec. 16, 2009, which is herein incorporated by reference in its entirety.

### BACKGROUND OF THE INVENTION

1. The Field of the Invention

The present invention relates to gardening. More specifically, the present invention relates to a system and method of gardening that maximizes the amount of vegetables, or other plants, that can be grown in planters while minimizing the amount of effort needed to start and maintain the garden.

2. Background

Gardening is one of America's most popular leisure activities. The reasons for planting a garden are many. Some people grow their own food to save money, while others garden just as a hobby. Still others plant a garden for the homegrown flavor and satisfaction of growing their own vegetables.

Whatever the motivation for gardening may be, for the garden to be successful, one must invest considerable amounts of time and effort to keep the garden neat and productive. After the excitement of planting is over, however, and summer activities begin to increase, the average gardener often does not have the time, or forgets, to weed and water the garden, which adversely impacts the garden's production.

Furthermore, when planting a vegetable garden one usually plants more seeds than are necessary in order to ensure that sufficient plants grow. Thus, a typical vegetable garden grown from seed often becomes overcrowded and the resulting plants are spindly because they do not receive the appropriate nutrients and sunlight. If the garden is not timely thinned out the quality of the vegetables will be compromised.

Additionally, there are many people who would plant a garden, but lack sufficient knowhow on how to start and raise a garden. Such individuals may be intimidated by the knowledge required to create a productive garden, including how to prepare the soil, how to properly plant the seeds and how to care for the plants as they grow.

### SUMMARY OF THE INVENTION

It is an object of the present invention to provide an improved system and method of gardening in planters that reduces the amount of time, effort and experience needed to maintain the garden while maximizing the amount of vegetables, or other plants, produced.

According to one aspect of the invention, a planter is provided having a base that is partially raised to form a channel along the inner wall of the planter. The channel is defined by the inner side walls of the planter and the resulting edges of the raised base. The channel retains water keeping the soil moist while openings in the raised base allow for draining of excess water to ensure the proper hydration of plants growing therein.

According to another aspect of the invention, soil comprised of coconut husk (coir), and/or other planting medium, may be provided. A planting medium, such as coir, peat or a combination of either or both with soil assists plant growth from seeds to maturity. The coir and peat are also advantageous because they are compact and lightweight when dry and may expand by about seventy-five percent (75%) when water is added. Thus, the amount of a planting medium, such as coir, required to fill the planter can be compactly packaged. Alternatively coir or peat along with nutrients can be provided and then supplemented with traditional soil by an end consumer.

According to another aspect of the invention, a planting template may be provided that directs a person to plant seeds in a particular location depending on seed type in order to maximize the amount of vegetables or other plants that can be grown in the modular gardening system.

In accordance with another aspect of the invention, a planting stick may be provided that aids a person in planting a seed at a depth for proper germination of a particular type of seed. The planting stick may have demarcations to indicate various depths that seeds can be planted.

According to still another aspect of the invention, a drain pan may be provided which receives one or more planters. The drain pan may receive the planters so as to leave a small area for airflow and/or an area for excess water to run in the event the planter(s) is over watered.

According to yet another aspect of the invention, a lid may be provided to facilitate germination, protect seeds or plants from adverse environmental conditions, or minimize moisture loss due to evaporation. The lid may comprise engagement members to facilitate placement of the lid on or removal of the lid from the planter. Additionally, the lid may comprise ventilation holes to prevent overheating of the plants or seeds.

Together various aspects of the invention provide a gardening system which provides nearly everything needed by the gardener to grow a garden in a confined space. This may enable gardeners with a wide variety of experience levels to successfully grow vegetables, herbs and/or other plans and thus find success in gardening.

Embodiments of the invention also include a method of modular gardening using planters and other parts of a system. The method includes selecting seeds to be planted in a planter. The seeds can be comprised of a single variety or selected from a multiple of varieties depending on the type of plants a person desires to grow. Using the planting template, a person may place the seeds in the proper location according to a planter's guide and at the proper depth using the planting stick. Proper placement of the seeds allows for maximum amount of vegetables, or other plants, that can be grown in a planter.

These and other aspects of the present invention are realized in a system and method of modular gardening in planters as shown and described in the following figures and related description. It will be appreciated that not all aspects of the system or method need be present and that various aspects of the system and method are set forth in the appended claims, which define the invention or inventions contained herein.

### BRIEF DESCRIPTION OF THE DRAWINGS

The above and other objects, features and advantages of the invention will become apparent from a consideration of the following detailed description presented in connection with the accompanying numbered drawings wherein:

FIG. 1 shows a perspective view of a planter in accordance with one aspect of the invention;

FIG. 2 shows a cut-away view of one aspect of a planter of the modular gardening system according to principles of the present invention;

FIG. 2A shows a bottom perspective view of a planter according to the present invention;

FIG. 2B shows a drain pan which receives the planter shown in FIG. 2A;

FIG. 2C shows a bottom perspective view of a lid which may be used with the planter in accordance with the present invention;

FIG. 2D shows a drain pan which may receive more than one planter;

FIG. 2E shows the drain pan of FIG. 2D holding three planters of the present invention;

FIG. 3 shows a side, cross-sectional view of a modular gardening system made according to principles of the present invention;

FIG. 4 shows a top view of a planting template according to the principles of the present invention;

FIGS. 5 and 5A show front and side views, respectively, of a planting stick for use in the gardening system of the present invention;

FIG. 6 shows a top view of one embodiment of the planting template directing a person to plant seeds in a particular location according to principles of the present invention;

FIG. 6A shows a planter's guide which can be used to provide instructions on how to use the template;

FIG. 7 shows a perspective view of one embodiment of the present invention wherein seeds planted according to the template of FIG. 6 have grown into plants; and

FIG. 8 shows a flow chart of a method according to the present invention.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Thus, it may be considered that any aspect shown in one drawing could be used in connection with structures shown in another drawing. Similarly, every embodiment need not accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

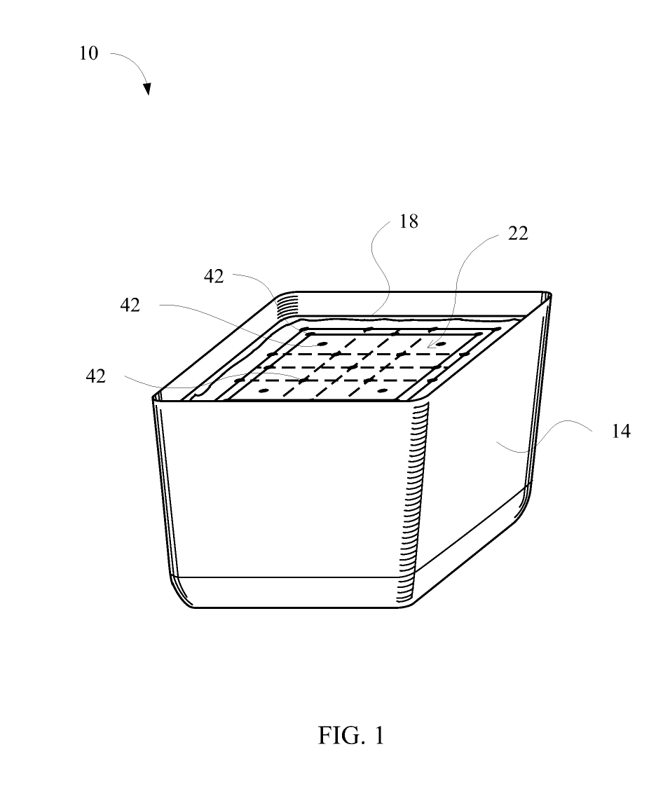

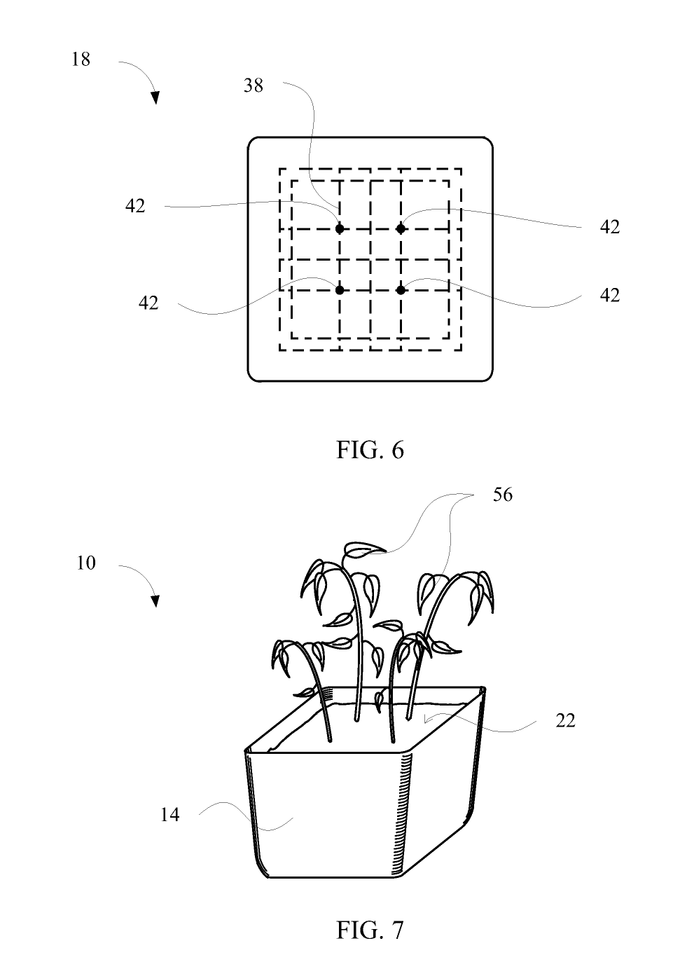

Turning now to FIG. 1, there is shown a perspective view of portions of a gardening system 10 in accordance with the present invention. The system 10 comprises a planter 14 wherein soil or other planting medium 22 is overlaid with a planting template 18 which directs a person to plant seeds in a particular location. The planting template 18 indicates a plurality of locations, such as locations 42, for planting seeds. The location at which a seed is to be planted within the gardening system 10 is dependent upon the type of seed that a person desires to plant. By referring to a planter's guide shown in FIG. 6 and planting seeds at locations according to the template 18 as indicated in the guide, the maximum amount of vegetables or other plants that can properly be grown in the planter 14 is made clear. This enables a person who has very little experience in gardening or in “square foot” gardening to grow vegetables or other desired plants.

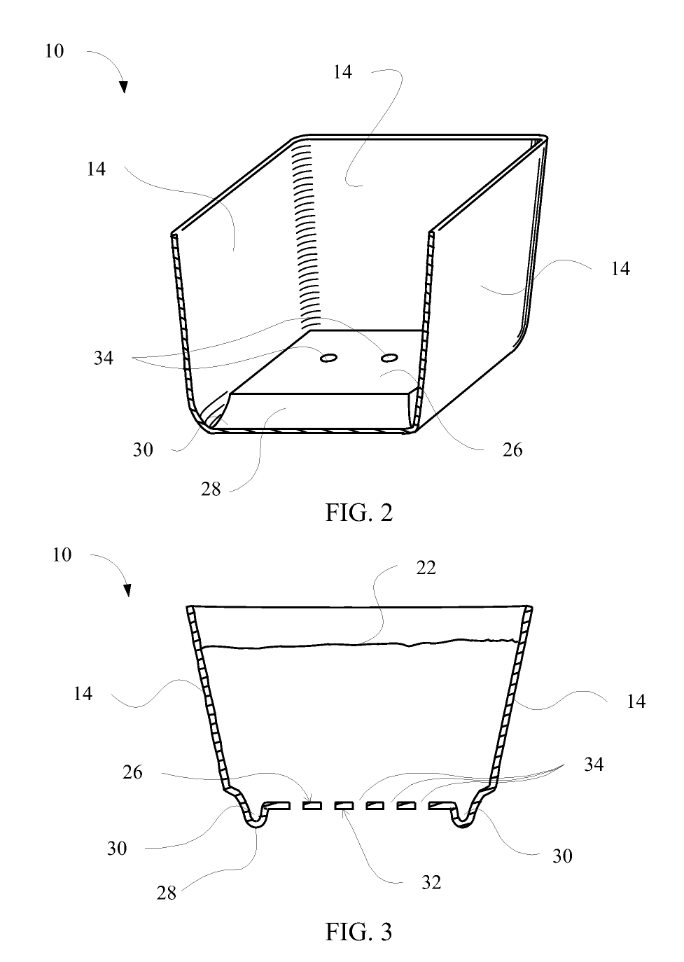

FIG. 2 shows a cut-away view of one aspect of a planter of the modular gardening system, generally indicated at 10. Walls 28 of a raised base 26 form a channel 30 with side walls 14 of the planter. Additionally, raised base 26 has a plurality of openings 34 (typically more than two may be present depending on the size and shape of the openings). The openings 34 allow excess water to drain and thereby prevent damage to the roots of the plants. However, channels 30 around the raised base are able to retain some water, thereby reducing the risk of the soil becoming too dry. Thus, this ability to regulate the amount of water in the planter ensures that plants are properly hydrated. Additionally, because some water is retained by channel 30, a person will not have to water plants grown in the planter as frequently.

FIG. 2A shows a bottom, perspective view of a planter, generally indicated at 10, formed in accordance with the present invention. The planter is similar to that shown in FIG. 2, except that the base portion 26 is recessed in to provide additional clearance for a drain pan (discussed in FIG. 2B). The walls 28 of the base 26 are still formed to leave a channel (similar to channel 30) to retain some water, while a plurality of openings 34 are formed in the raised portion of the base to allow drainage.

FIG. 2B shows a top perspective view of drain pan 37. The drain pan 37 is preferably formed with upwardly sloping sidewalls and may include recesses 24 to receive contours on the bottom of the planter 10 so that the bottom of the planter 10 nests in the pan while leaving a small area for airflow or for excess water to run out in the case of over watering. The bottom of the drain pan 37 may be flat or contoured, but is preferably configured to leave a gap or cavity beneath the base 26 to allow for adequate drainage. One skilled in the art will appreciate that alternatively the bottom of planter 10 may include recesses to receive contoured surfaces on drain pan 37 in order to achieve a similar result, e.g. providing an area for airflow or for excess water to run between the drain pan 37 and planter 10.

It should also be appreciated that the drain pan 37 can be modified to accommodate more than one planter 10. For example, as can be seen in FIGS. 2D and 2E, the drain pan 37′ can include sufficient recesses 24′ to receive multiple planters, such as, for example, three planters 10 in a side-by-side array. Thus, a person may be able to more conveniently manage his or her gardening space. Of course, it is contemplated that drain pans which accommodate more or less than three planters may be provided.

Turning now to FIG. 2C, there is shown a lid 39 which can be used with a planter in accordance with aspects of the present invention. While the lid 39 can be used with the planter during shipping, it also can be used to facilitate gardening. Four engagement members 41 on the corners of the lid 39 can be used to conveniently grasp the lid for placement on or removal from the planter 10 (FIG. 2A). Additionally, the engagement members 41 also provide ventilation to prevent overheating of the plants. Alternatively or in addition thereto, vent holes 43 may be provided to provide ventilation and avoid overheating.

Newly sprouted plants are often sensitive to environmental conditions, such as cold temperatures, heavy rains and the like. Likewise, many seeds will not germinate unless the soil is sufficiently warm. The lid 39 allows the gardener to have greater control over the environment within the planter 14 (FIG. 2A) to promote growth. For example, placing the lid 39 on the planter 14 after planting seeds and placing the planter in direct sunlight can warm the soil and facilitate earlier germination.

Likewise, using the lid 39 can help retain heat in the planter and prevent harm to the plants due to frost, heavy rains or the like. This is especially important in areas that have late frost cycles in the spring. If frost or heavy rains are predicted, the gardener need only add the lid 39 until the threat has passed.

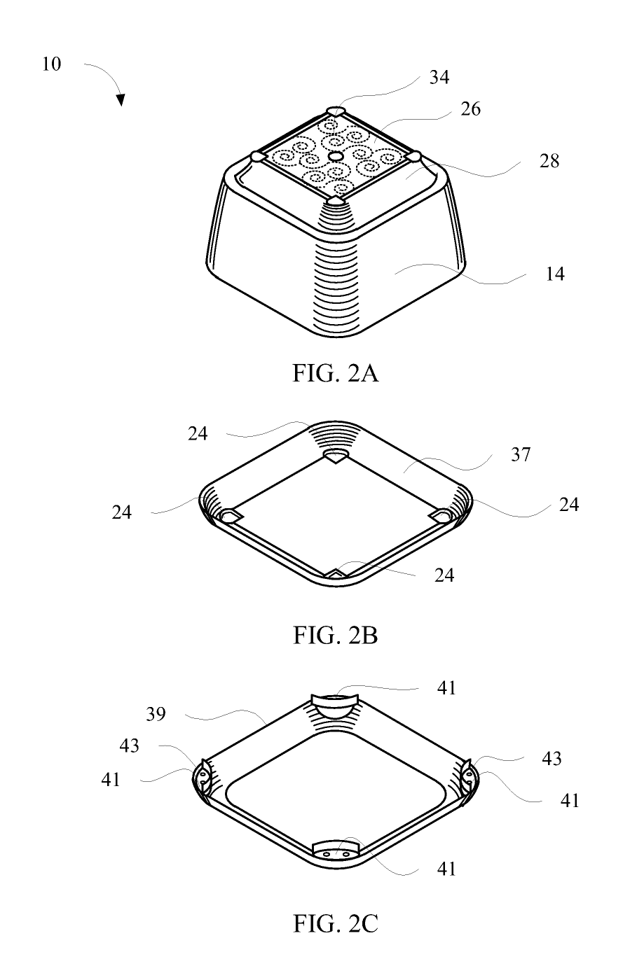

The lid 39 can also be used to help minimize moisture loss. Thus, for example, if the gardener must be away for several days and cannot water the plants, the planter 14 can be placed out of direct sunlight, watered appropriately, and the lid 39 placed on the planter. The lid 39 minimizes water loss due to evaporation, while the openings 34 (FIG. 2A) prevent the water content from being too high. As the plants grow, their ability to go prolonged periods without water increases and the need for the lid 39 decreases. The lid 39 can be made from a similar material and in a similar color as the planter 14 and drain pan 37 for aesthetics. In the alternative, the lid could be transparent to allow sunlight to reach any newly germinated plants while still retaining heat and moisture. FIG. 3 shows a cross-sectional view of a planter, generally indicated at 10, according to principles of the present invention similar to that shown in FIG. 2A and filled with a planting medium 22. The planting medium 22 (which has been developed to assist plant growth) may be comprised of coconut husk, peat or other suitable material. According to one aspect of the present invention, the planting medium 22 is comprised of coconut husk which expands when water is added to it making the coconut husk more efficient to package, as well as additives such as plant nutrients. The coconut coir or husk may be the primary ingredient in the planting medium or it may be mixed with other planting mediums such as peat or traditional soil. Peat may also be used as a stand alone medium. One advantage of dried peat and coir or husk is that they are lightweight and can be compressed to a small size and then easily rehydrated. Thus, either can be used as most of the planting medium or can be mixed into soil or other conventional planting mediums.

Also, channel 30 can be more clearly seen in FIG. 3 which is shown as being defined by side walls 14 and edges 28. Channel 30 is designed to retain water and aid in keeping the planting medium 22 moist, while the openings 34 keep the soil from being saturated with water. Additionally, as a result of the base 26 of the planter being raised, a cavity 32 is formed underneath the planter. Cavity 32 allows excess water to escape out of openings 34 (see FIG. 2) and remain out of the planting medium. Thus, the planter 10 is able to maintain the appropriate hydration of planting medium 22 and provide the optimum growing environment for plants grown in the planter 10.

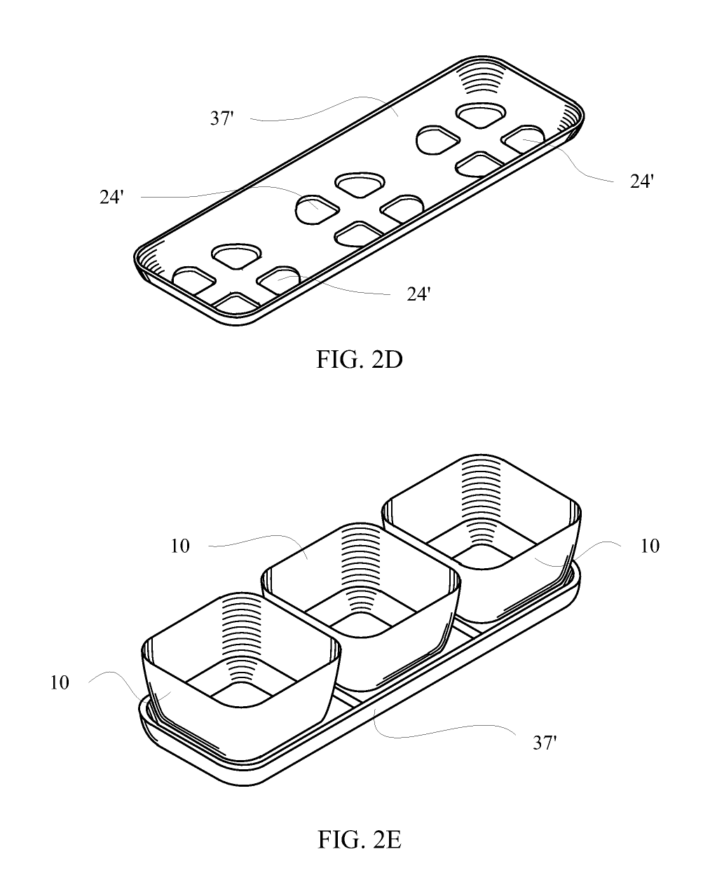

FIG. 4 shows a top view of a planting template 18. Planting template 18 comprises a grid 38 wherein planting locations, such as locations 42, are indicated. By referring to a planter's guide (shown in FIG. 6A), a person is able to determine the proper locations 42 to plant seeds depending on the variety of seed or seeds that one desires to plant. This can be accomplished, for example, by providing an indicator at different locations, such as different color indications for planting particular plants. Thus, for example, planting locations 42a for tomatoes could be red, while planting locations for peppers 42b could be green and beans 42c could be blue. Thus, the template shows a first location, a second location, etc., for planting a particular type of seed. With the planting template 18, even a very inexperienced gardener could be assured that he or she is planting the plants with the proper spacing.

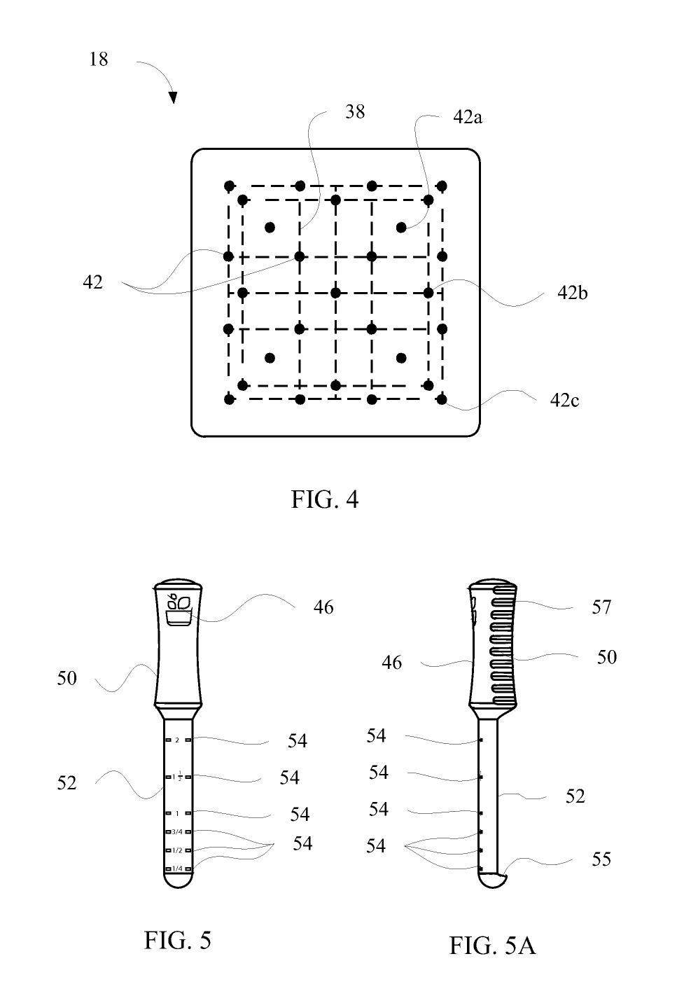

FIGS. 5 and 5A show front and side views, respectively, of a planting stick 46 in accordance with one aspect of the invention. Planting stick 46 can be comprised of a handle 50 and a shaft 52. Shaft 52 can be manufactured from a variety of materials including wood, steel, plastic, etc. Additionally, shaft 52 has demarcations 54 thereon indicating the proper depths a person should plant a seed. By referring to the planter's guide to determine the proper depth a particular variety of seed should be planted, a person is able to plant the seed at the optimum depth for germination by pressing the shaft 52 of the planting stick 46 into the soil until the appropriate demarcation is level with the top of the soil. Using the planting stick 46 in combination with the template 18 ensured both proper depth and proper spacing.

As shown in FIG. 5A, the shaft 52 can also include a channel or void 55. The channel can be used to scoop out small amounts of the planting medium to ensure that the seed falls to the proper depth in the planting medium during planting. The handle 50 can also have ribs 57 or an otherwise contoured surface to facilitate gripping.

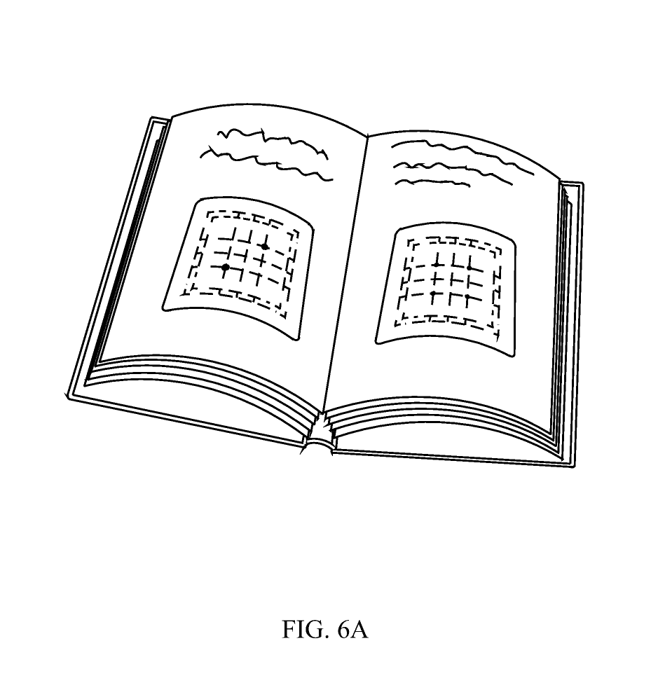

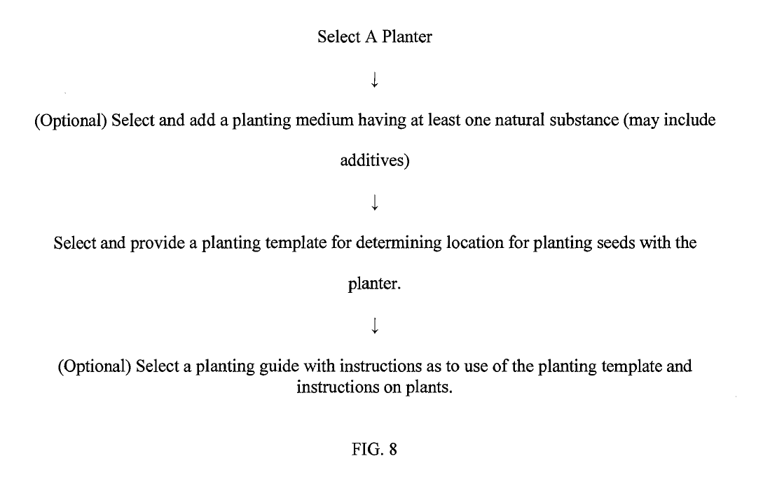

FIG. 6 shows a top view of one embodiment of the proper locations on planting template 18 for placing a particular variety of seeds according to the planter's guide. By planting the particular variety of seeds at locations 42 a person is able to maximize the amount of vegetables or other plants 56 that can be grown in the gardening system 10 of FIG. 7 without the need to thin out unwanted plants due to over planting. Furthermore, avoiding overplanting seeds initially ensures that all nutrients in the soil are utilized by plants that are ultimately destined for harvest. Instructions as to how to use the template may be provided in a planter's guide, shown in FIG. 6A.

FIG. 7 shows a perspective view of one embodiment of the present invention wherein seeds planted according to the template described in FIG. 6 have grown into plants. It will be appreciated that multiple gardening systems may be utilized in accordance with principles of the present invention. When multiple systems are used they can be arranged in any location or configuration in order to make use of available space and sunlight and eliminating the need for a large plot of land to grow a garden. Moreover, the planters can be manufactured in a variety of shapes, sizes and colors, allowing a person to decorate any room, porch, deck, etc. Thus, for example, planters that are 12 inches square could be used on a deck, while planters that are 8 inches square or 6 inches square could be used in a window. There is thus disclosed an improved system and method of gardening that maximizes the amount of vegetables, or other plants, that can be grown in planters while minimizing the amount of effort needed to maintain the garden. It will be appreciated that numerous changes may be made to the present invention without departing from the scope of the claims. For example, the planting medium may be natural soils or composted materials and may include other additives and nutrients.

What is claimed is:

1. A modular gardening system comprising:
a planter; and
a planting template for determining the location for planting a seed within said planter when multiple seeds are planted in said modular planter.

2. The modular gardening system of claim 1, further comprising a planting medium for placing in said planter.

3. The system of claim 2, wherein the planting medium comprises at least one of coconut husk, coir and peat.

4. The system of claim 3, wherein the planting medium further comprises additives.

5. The system of claim 4, wherein the planting medium comprises soil.

6. The system of claim 1, wherein the planter has a raised base having a plurality of openings therein for allowing water to drain from the planter and wherein edges of the raised base and side walls of the planter form a channel disposed below the raised base for retaining water.

7. The system of claim 1, wherein the planting template comprises a grid which indicates the proper locations to plant a variety of seeds, said grid including a first location having a first indicator and a second location having a second indicator, wherein a first variety of seed is planted at said first location and a second variety of seed is planted at said second location.

8. The system of claim 1, further comprising a planting stick with demarcations indicating the proper planting depth of a seed.

9. The system of claim 1, further comprising a drain pan for receiving the planter, the drain pan being configured to be spaced away from a central portion of a bottom of the planter so as to allow for a space for airflow between the planter and the drain pan.

10. The system of claim 1, further comprising a plurality of planters.

11. The system of claim 1, further comprising a lid configured for selective placement on top of the planter so as to selectively protect plants growing therein from environmental conditions.

12. A method of making a modular gardening system, the method comprising the steps of:
selecting a planter; and
selecting a planting template for marking the location for planting a seed in a the planting medium when the planting medium is in the planter and coupling the planting template with the planter.

13. The method of claim 12, wherein the method comprises selecting a planting medium for placing in said planter and placing the planting medium in the planter.

14. The method of claim 12, wherein the method comprises selecting a planting guide to provide instructions as to use of the template and proper growing instructions.

15. The method according to claim 12, wherein the method comprises selecting a planting medium which expands upon the addition of water.

16. The method according to claim 13, wherein the method comprises selecting a planting medium expands by about seventy-five percent (75%) upon the addition of water.

17. The method according to claim 13, wherein the method comprises using a planting medium comprising coconut coir or coconut husk coir.

18. The method according to claim 12, wherein the method further comprises the step of selecting a planting medium containing additives for plant nutrition.

19. The method according to claim 12, wherein the method further comprises the step of including a planting stick to plant seeds at the proper depth in locations indicated on said planting template.

20. The method according to claim 12, wherein the method further comprises the step of providing a planting guide which refers to the proper locations on said planting template to plant seeds.

21. The method according to claim 12, wherein the method further comprises the step of selecting a lid which may be placed on the planter to control environmental conditions within the planter.
